(19) United States
(12) Patent Application Publication
(10) Pub. No.: US 2011/0038148 A1
(43) Pub. Date: Feb. 17, 2011

(54) LED LIGHT FIXTURE

(76) Inventor: Alan R. Pyle, Indianapolis, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/542,162

(22) Filed: Aug. 17, 2009

(51) Int. Cl. F21V 7/00; F21S 4/00

(52) U.S. Cl. 362/235; 362/249.02

(57) ABSTRACT

A light fixture for holding LED tubes. A pair of end caps are held together by an elongated member. Female connectors mounted to the end caps receive the male connectors of the LED light tubes. The female connectors are mounted to the end caps allowing for the pre-selection of the angle of illumination.

### BACKGROUND OF THE INVENTION

1. Field of the Invention

The present invention relates generally to the field of light fixtures.

2. Description of the Prior Art

Fluorescent light tubes have opposite male connector ends removably mounted to female connectors referred to as tombstones. Tombstones are fixedly mounted to a light fixture generally suspended from a ceiling or recessed into the ceiling. The male connectors are slid into the female slots and the light tubes are then locked or rotated to mount the fluorescent tube to the light fixture. Fluorescent tubes radiate light 360 degrees around the tube. As a result, much of the light is lost since the light reflects against the ceiling or fixture. While fluorescent tubes are more efficient in generating light as compared to an incandescent bulb, the tubes have to be frequently replaced requiring substantial maintenance cost.

LED (light emitting diode) light tubes are available and have male connector ends identical to those found on fluorescent tubes. Thus, the LED light tubes are removable mounted to existing tombstone female socket connectors provided in the prior fluorescent light fixtures. LED light tubes use semi-conductor diodes that release energy in the form of a photon (light) when current flows from the anode side to cathode side. In an incandescent lamp, an element is heated by electric current until it glows or emits light. In a fluorescent lamp, an electric arc excites mercury atoms, in turn, generating ultraviolet radiation that strikes a phosphor coating and emits visible light. The LED light tube is much more efficient and uses substantially less electricity to generate an appreciable greater amount of light.

The LED light tube typically includes a reflector extending the length of the tube on one side of the tube to reflect the light emitted by the LEDs downward. As a result, when the LED light tubes are mounted in the prior fixtures that were designed for fluorescent tubes, the light shines vertically downward. This is true since the tombstones or female socket connectors are fixedly mounted to the fixture and do not take into account any reflector built into the LED tube.

When LED light tubes are placed in fixtures designed for fluorescent tubes, all of the LED light from multiple tubes is concentrated in a small area with little spread. The fixture disclosed herein fixedly mounts the tombstones at different fixed angles or provides tombstones that are adjustable to provide various illumination angles thereby achieving superior illumination.

The adjustable tombstone allows the user to customize the fixture based on the specific illumination need. For example, an owner of a large warehouse may point every light tube vertically down to light aisles while smaller commercial projects may angle the light tubes outward relative to the vertical to maximize the spread of the light.

A significant additional advantage of the LED light tube as compared to the fluorescent light tube, is that the LED light tube does not require or use ballast to regulate the amount of electricity that flows to the diodes. Use of the prior light fixtures designed for fluorescent tubes therefore require rewiring around the ballast mounted in the fixture in order to use the fixture for LED tubes. Thus, the LED light fixture disclosed herein has been designed without a ballast.

Further, the prior light fixtures designed for fluorescent tubes normally have a cover on top of the fixture that helps reflect the light downward. Such a cover is not necessary with the fixture designed specifically for LED light tubes since the LED tubes have built within each tube a reflector. Providing a fixture without a top cover allows greater flexibility in design, makes the fixture less bulky and reduces the cost of the fixture.

### SUMMARY OF THE INVENTION

One embodiment of the present invention is an LED light fixture connectible to an electrical supply located external to the light fixture. The fixture has a pair of opposed end caps or supports connected together by an elongated member. Each end cap has a plurality of female connectors thereon that are aligned with corresponding female connectors on the opposite end cap. The female connectors removably receive male connectors located at the opposite ends of an LED light tube. The female connectors are oriented on the end caps to shine the light from each LED light tube downward at a preselected angle. In one version, the female connectors are movably mounted to the end caps allowing the user to manually move the connectors to a desired angle to direct the light from each light tube downward at different angles relative to the vertical.

It is an object of the present invention to provide a fixture for holding an LED light tube.

A further object of the present invention is to provide a light fixture allowing for the pre-selection of the angle of illumination associated with an LED light tube mounted to the fixture.

An additional object of the present invention is to provide a new and improved light fixture.

Related objects and advantages of the present invention will be apparent from the following description.

### BRIEF DESCRIPTION OF THE DRAWINGS

FIG. 1 is a perspective view of a prior art LED light tube.

FIG. 2 is a perspective exploded view of a preferred embodiment of a light fixture incorporating the present invention.

FIG. 3 is an enlarged fragmentary and perspective view of an end cap of the fixture of FIG. 2.

FIG. 4 is a bottom perspective view of the end cap of FIG. 3.

FIG. 5 is a schematic diagram illustrating the orientation of the female connectors.

FIG. 6 is a perspective view of an alternate embodiment of the light fixture incorporating the present invention.

FIG. 7 is an enlarged perspective view of one of the end caps of FIG. 6.

FIG. 8 is an enlarged perspective view of a mounting strip for holding the female connectors and female connector mounting brackets.

FIG. 9 is a side view of a female connector mounting bracket.

FIG. 10 is a front view looking in the direction of arrows 10-10 of FIG. 9.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

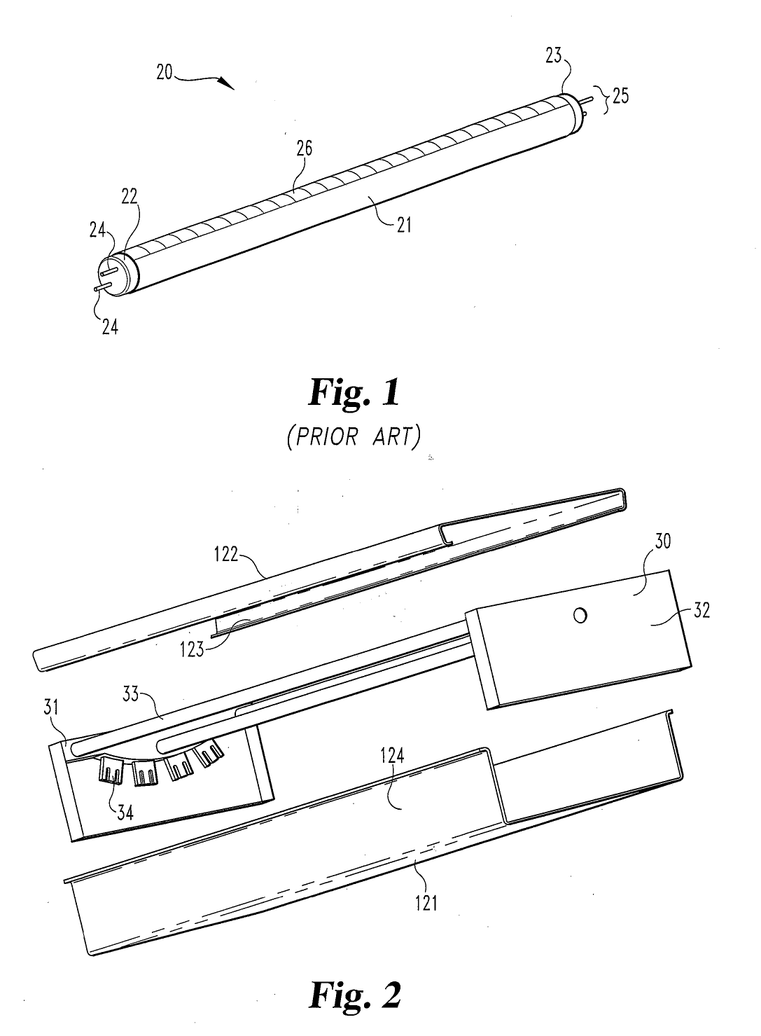

Referring now more particularly to FIG. 1, there is shown a commercially available LED light tube 20 having a cylindrical tube 21 with a pair of end covers 22 and 23 affixed thereto. A first pair of male connectors 24 extend outwardly from end cover 22 and a second pair of male connectors 25 extend outwardly from cover 23. Connectors 24 and 25 are connected to a plurality of LEDs mounted within tube 21 which will emit light when connectors 24 and 25 are connected to a source of electrical energy. A reflector 26 is positioned within the tube or outside of the tube to direct the light emitted by the diodes downward. In other words, assuming reflector 26 is positioned atop tube 21 then the light would be reflected in a downward direction. Reflector 26 may take a variety of forms, such as, a reflective coating or shield. Such LED lighting tubes are available from Elumenus, 9888 East 121^{st} Street, Fishers, Ind. 46038.

The preferred embodiment of the light fixture incorporating the present invention is shown in FIG. 2. Fixture 30 includes a pair of identical end caps 31 and 32 joined together by a plurality of elongated members, conduits or rods 33 having their opposite ends attached to end caps 31 and 32 thereby supporting the end caps in spaced relationship. A plurality of female connectors 34 are mounted to end cap 31 and to end cap 32 and are arranged in pairs to allow an LED light tube to be mounted to each pair. Female connectors 34 are commercially available and referred to as tombstones. Female connectors 34 are used to hold the opposite ends of fluorescent tubular lamps. The connectors are available from a variety of sources including Harrington Lights of Chesterfield, N.H. 03443.

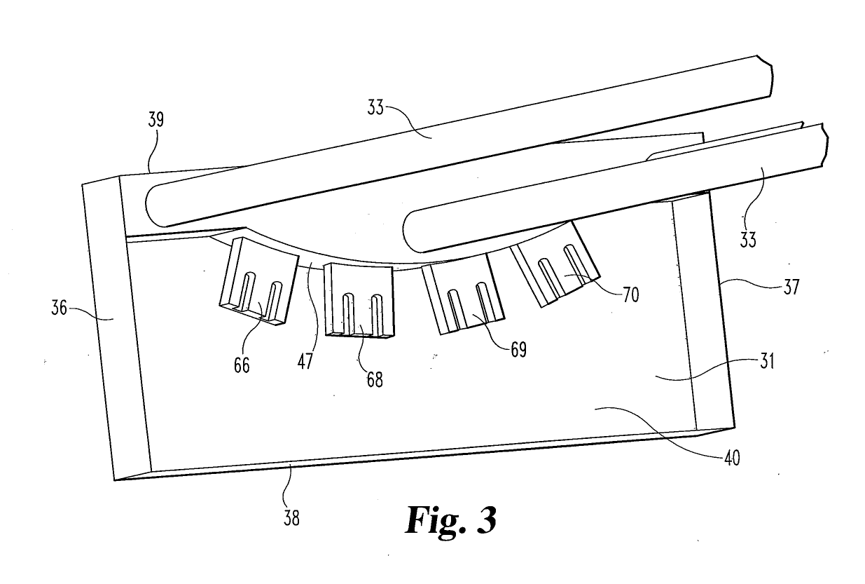

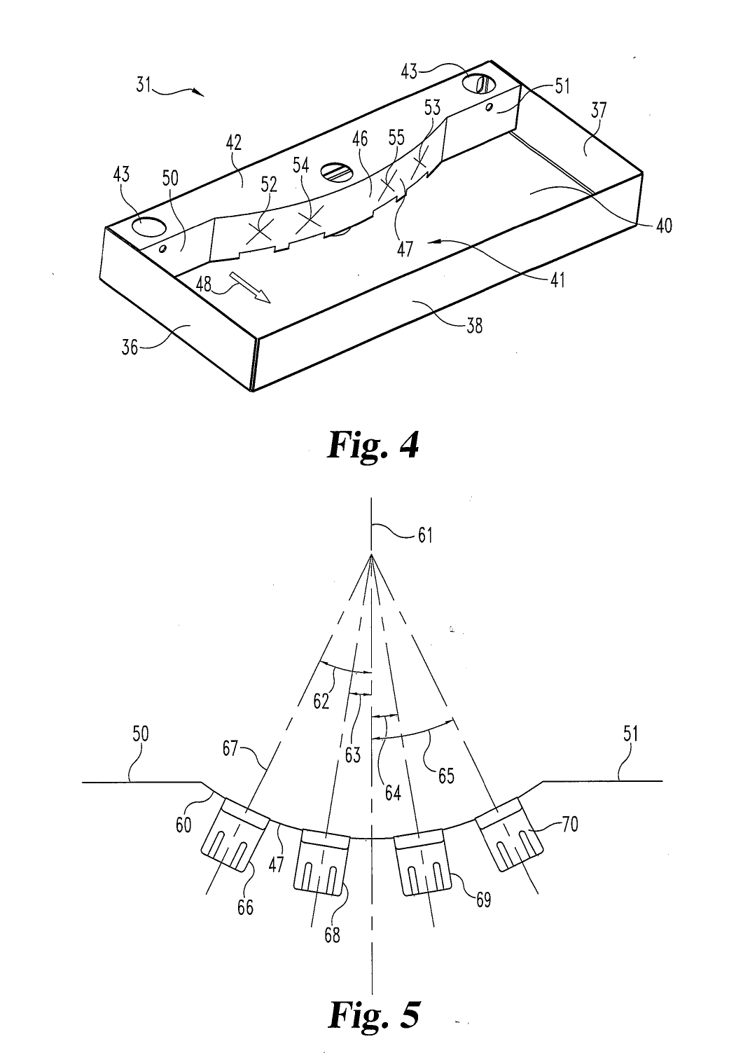

End cap 31 (FIG. 3) will now be described it being understood that an identical description applies to end cap 32. End cap 31 includes a pair of sidewalls 36 and 37 joined to a bottom wall 38 and top wall 39 in turn joined to an outer wall 40. Thus, end cap 31 forms a rectangular housing having a recess 41 facing an identical recess formed in end cap 32. A downwardly extending flange 42 (FIG. 4) is connected to the top wall and includes a plurality of holes 43 through which tubes 33 extend.

Mounting wall 46 is perpendicularly arranged with respect to flange 42 and outer wall 40 and is connected to each wall. Wall 46 has a curved portion 47 that bows downwardly in the direction of arrow 48 with curved portion 47 being located between the horizontally extending end portions 50 and 51.

The end portions 52 and 53 of curved portion 47 are located higher in elevation than the middle portions 54 and 55 of the curved wall. In one particular embodiment, a separate female connector is mounted at each location 52, 53, 54 and 55 thereby positioning the female connectors mounted at locations 52 and 53 at an elevation higher than the female connectors located at locations 54 and 55. Further, surface 60 (FIG. 5) curves upwardly in locations 52 and 53 (FIG. 4) relative to locations 54 and 55. Thus, the female connectors located at locations 52 and 53 are positioned at a greater angle relative to vertical as compared to those at locations 54 and 55.

Curved portion 47 provides a downwardly facing surface 60 against which the base of the female connectors are positioned against and mounted thereto. Female connector 66 has a longitudinal axis 67 arranged at angle 62 relative to the vertical axis 61. Likewise, female connectors 68, 69 and 70 have longitudinal axis arranged respectively at angles 63, 64 and 65 relative to vertical axis 61. When four separate LED light tubes 20 (FIG. 1) are mounted respectively to connectors 66, 68, 69 and 70, so that the reflector portion 26 of each light tube is arranged in the upper portion of the tube, then the reflector portion 26 is automatically positioned to shine the light downward at angles 62, 63, 64 and 65 respectively thereby providing a broader range of illumination.

The female connectors on end cap 31 are aligned with respective female connectors on end cap 32. That is, the end caps have aligned pairs of female connectors to allow the LED light tubes to extend horizontally and parallel to rods 33 when the light fixture is in its normal position with the end caps' bottom wall and top wall extending horizontal.

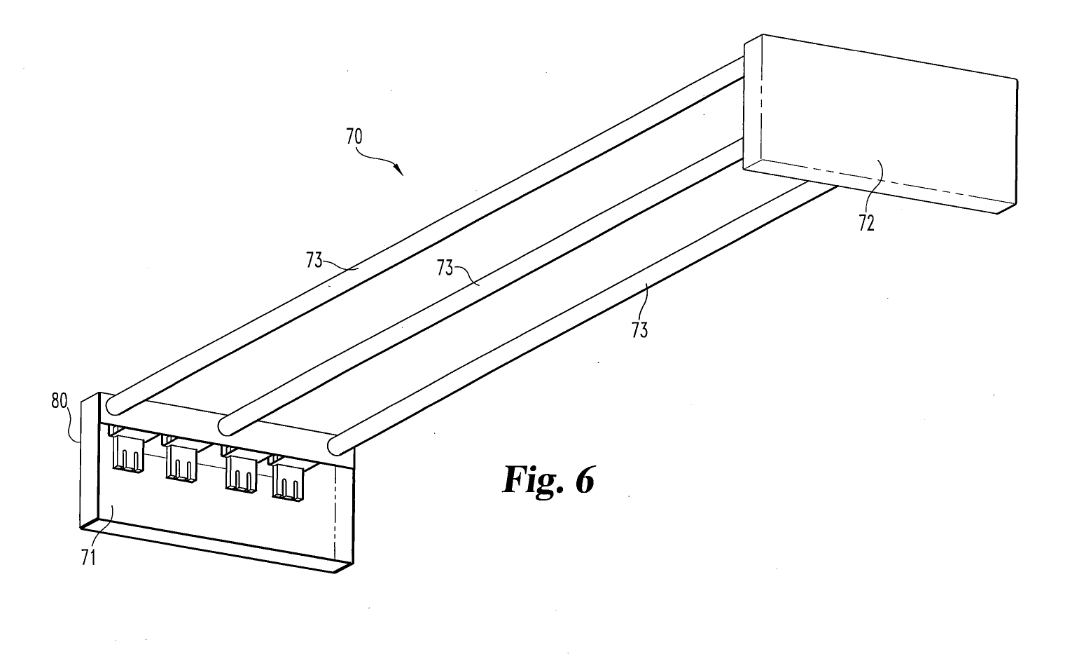

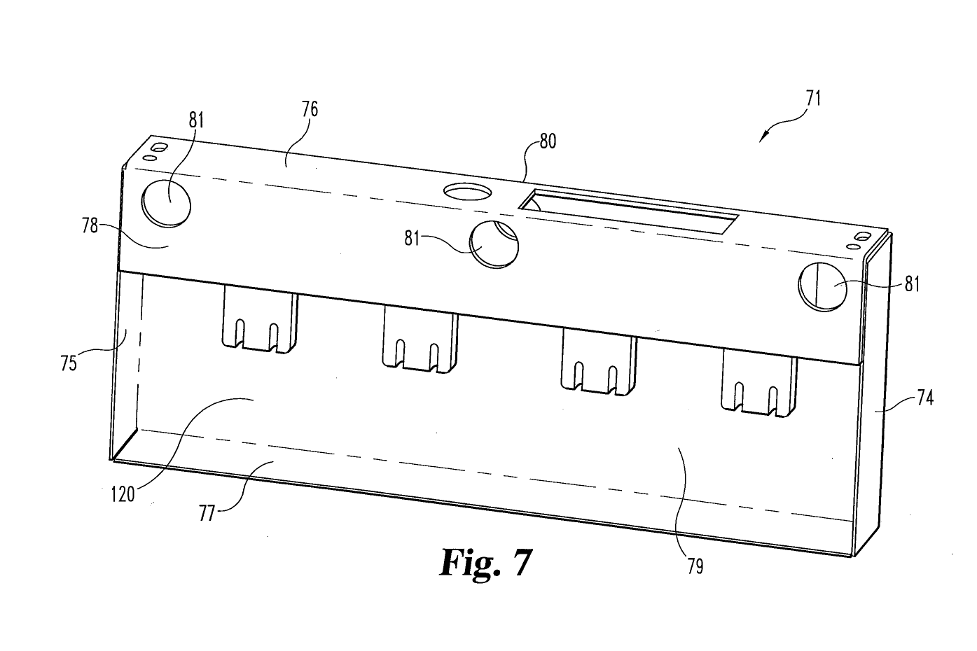

An alternate embodiment of the light fixture is shown in FIG. 6 and includes a light fixture 70 with a pair of identical end caps 71 and 72 joined together by horizontally extending parallel rods 73. Fixtures 30 and 70 are different in that the mounting brackets used to hold the female connectors in fixture 70 may be manually moved thereby allowing the user to orient the LED tubes at the desired angle of illumination whereas the female connectors provided in fixture 30 are fixedly mounted and once assembled by the manufacturer cannot be moved.

End cap 71 will now be described it being understood that an identical description applies to end cap 72. End cap 71 (FIG. 7) includes a pair of side walls 74 and 75 joined to a top wall 76 and bottom wall 77. A flange 78 extends downwardly from top wall 76 and terminates intermediate the top wall 76 and bottom wall 77. Wall 78 is spaced apart from the outwardly facing wall 80 (FIG. 6) thereby forming an enclosure to which the electrical wiring connected to the female connectors extend. Three holes 81 receive an end of rods 73 which are secured to the end cap in any number of ways. For example, the ends of the rods may be fastened to outward facing wall 80 or to the top wall 76 with conventional fastening devices, such as screws.

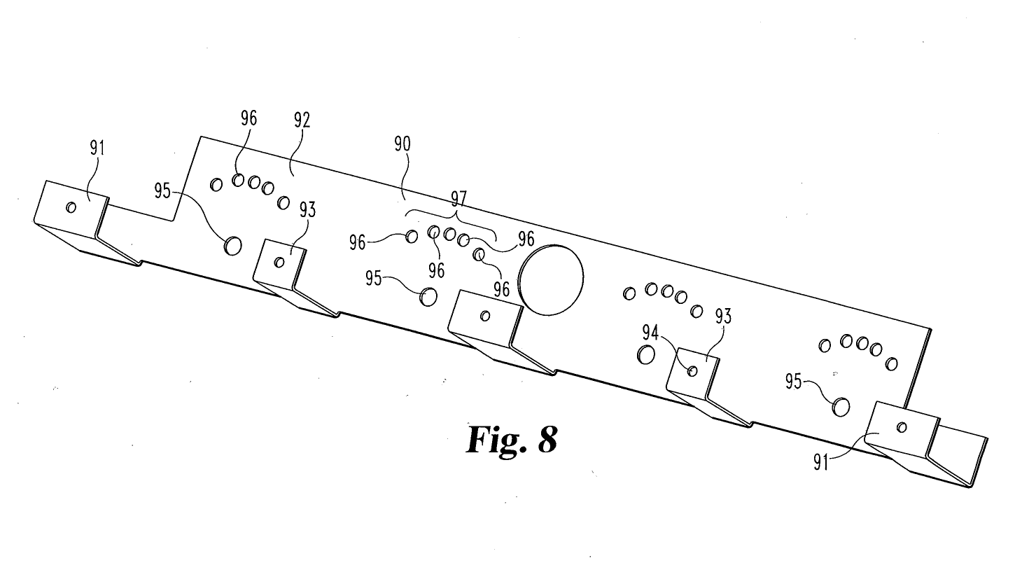

Mounting plate 90 (FIG. 8) includes a vertically extending main wall 92 having five outwardly extending flanges 91 integral therewith. Flanges 91 each have an upturned end 93 with a hole 94 extending there through. Plate 90 is positioned within the end cap so that the upturned flanges 93 contact the inside surface of the downwardly extending flange 78 with fasteners then extending through flange 78 into holes 94 securing plate 90 to the end cap.

The end cap includes a plurality of rivet holes 95 located beneath a radial pattern 97 of holes 96. For example, pattern 97 includes five dimple holes 96 located in pattern 97 having its focus at hole 95.

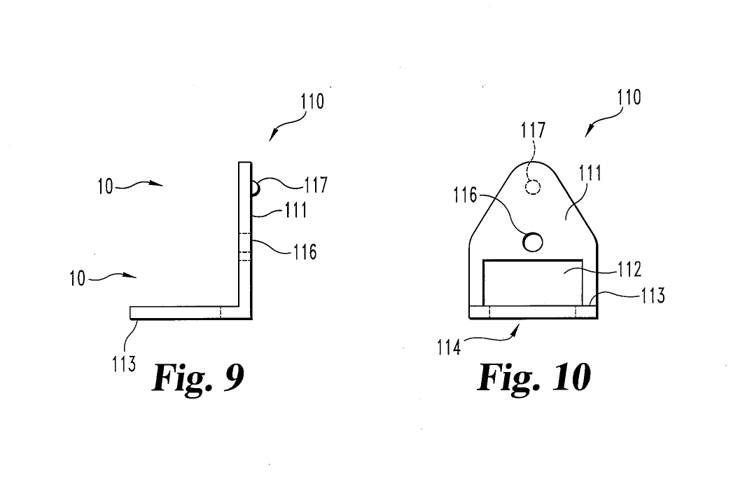

Each female connector is mounted in a mounting bracket 110 (FIG. 9) having a vertically extending wall 111 with a flange 113 extending perpendicularly therefrom. A hole 116 is provided in wall 111 to allow a fastener to extend through hole 116 and hole 95 (FIG. 8) thereby pivotally and movably mounting the bracket to wall 92. A dimple or projection 117 extends rearwardly from wall 111 and is slidable within each pattern 97 to be seated in a particular hole 96 as the mounting bracket is pivoted. The female connectors extend through hole 114 provided in flange 113. A rectangular opening 112 is provided in wall 111 allowing the enlarged head of the female connector to be positioned therein while the body of the female connector extends through hole 114. Thus, mounting bracket 110 and its associated female connector may be rotated about an axis extending through holes 116 and 95 allowing projection 117 to be positioned in a particular hole 96 depending upon the angle of illumination desired for the LED light. That is, the reflector 26 (FIG. 1) of tube 20 is oriented to shine the light downwardly at an angle relative to the vertical with the angle determined by which hole 96 the dimple 117 is positioned. The entire assembly consisting of plate 90 along with mounting brackets 110 and female connectors 34 is mounted within the end cap with the upturned flanges 93 being positioned inwardly and adjacent flange 78 (FIG. 7) positioning the female connectors within a recess 120 (FIG. 7) formed by the side walls 74 and 75, bottom wall 77, top wall 76 and wall 80 of the end cap.

Many variations are contemplated and included in the present invention. For example, the LED light fixtures disclosed herein may have any number of LED light tubes mounted thereto. For example, a fixture may have two, four, six or eight LED light tubes depending upon the amount of illumination required. Further, light fixtures 30 and 70 may include optional top covers and translucent bottom covers. For example, fixture 30 (FIG. 2) is shown having a translucent bottom cover 121 and a top cover 122. The top cover extends over conduits 33 and has downwardly extending flanges 123 that frictionally engage the upstanding flanges 124 of translucent bottom cover 121. Translucent bottom covers may be desired in the event the fixtures are located in ceiling recesses whereas the top covers protect the LED light tubes from external projections. The covers may or may not be used with either fixture disclosed herein. In the event the covers are not being used, then air circulation around the LED light tubes is improved.

The end caps 31 and 32 of fixture 30 and 71 and 72 of fixture 70 are hollow with the interior compartment for end caps 31 and 32 and 71 and 72 formed respectively by an outer wall 40 and 80 facing away from the fixture and flange 42 and 78. The wiring connected to the female connectors is routed through the hollow compartments and outward to a source of electrical energy. Additional variations of the routing of the wiring is contemplated and included in the present invention. The rods or conduits 33 and 73 holding the end caps together for fixtures 30 and 70 are hollow with the wiring common to the connectors on both end caps extending through the middle conduits 33 and 73 from one end cap to the opposite end cap.

While the invention has been illustrated and described in detail in the drawings and foregoing description, the same is to be considered as illustrative and not restrictive in character, it being understood that only the preferred embodiments has been shown and described and that all changes and modifications that come within the spirit of the invention are desired to be protected.

What is claimed is:

1. An LED light fixture connectable to an electrical supply located external to the light fixture comprising:
a plurality of LED light tubes each having a cylindrical tube with LEDs therein, each tube having a first end with a first male connector extending therefrom and a second end with a second male connector extending therefrom, said LEDs in each tube electrically connected to said first male connector and said second male connector;
a first end support;
a second end support spaced apart from said first end support and being parallel therewith to receive said LED light tube therebetween:
female connectors mounted to said first end support and said second end support with each female connector mounted to said first end support aligned with a corresponding female connector mounted to said second end support to enable mounting of the LED light tubes to said female connectors, said female connectors oriented to shine light from said LED light tubes downwardly at angles with the vertical; and,
a rigid member extending between and connected to said first end support and said second end support to maintain said alignment between said female connectors on said first end support and said female connectors on said second end support, said first end support and said second end support along with said rigid member forming a housing for said LED light tubes.

2. The light fixture of claim 1 wherein:
said housing has an open top and an open bottom extending from said first end support to said second end support allowing air to freely circulate around said light tubes; and,
said tubes have light reflectors to direct light emitted by the LEDs, said reflectors oriented on said tubes direct light from the LEDs through said open bottom.

3. The light fixture of claim 2 wherein:
said rigid member is a first rod with opposite ends connected to said first end support and said second end support supporting said first end support and said second end support in parallel relationship

4. The light fixture of claim 3 and further comprising:
a second rod with opposite ends connected to said first end support and said second end support supporting said first end support and said second end support and being parallel to said first rod.

5. The light fixture of claim 5 wherein:
said first end support and said second end support form respectively a first recess and a second recess that open toward each other with said female connectors being mounted within said first recess and said second recess with said tubes extending into each recess.

6. The light fixture of claim 1 wherein:
said plurality of parallel LED light tubes have reflectors to reflect light with said tubes extending between said first end support and said second end support, said female connectors on said first end support and on said second end support oriented to position said reflectors of said tubes to direct light from said tubes at a variety of angles relative to vertical to maximize the spread and intensity of light showing downwardly from said housing.

7. The light fixture of claim 6 wherein:
said female connectors are movably mounted to said first end support and said second end support and are manually adjustable to orient each LED light tube directing light therefrom at selectable angles relative to vertical.

8. The light fixture of claim 7 and further comprising:
assemblies mounted to said first end support and said second end support, said assemblies having a back plate and mounting brackets movably mounted to said back plate for holding said female connectors, said back plate and mounting brackets include interacting dimple/recess combinations to allow said brackets to be moved to selected angular positions relative to vertical; and wherein:
said female connectors are mounted to said brackets and move with said brackets to said selected angular positions.

9. The light of claim 8 and further comprising:
a top safety cover mounted to said housing and extending between said first end support and said second end support; and,
a translucent bottom safety cover mounted to said housing allowing light reflected off reflectors from said light tubes to shine therethrough.

10. The light of claim 1 and further comprising:
locators having locating surfaces on said first end support and said second end support with said female connectors being positioned relative to said surfaces to hold said female connectors and light tubes at a variety of angles to vertical direct light from said tubes downwardly at a variety of pre-determined angles relative to the vertical.

11. An LED light fixture for holding LED light tubes with LED's mounted therein and with said tubes having opposite ends and male electrical connectors secured to said ends comprising:
a pair of spaced apart end caps with mutually facing sides;
female electrical connectors mounted to said mutually facing sides with said female connectors oriented on said mutually facing sides to matingly receive male electrical connectors of LED light tubes when said light tubes extend between and are mounted to said pair of end caps;
means provided on said end caps to orient said female electrical connectors and said light tubes to shine light from said light tubes at a variety of angles relative to vertical; and,
an elongated support extending between and fastened to said end caps keeping said end caps in spaced relationship with each other with said support and said end caps forming a frame.

12. The light fixture of claim 11 and further comprising
a top cover mounted to said frame; and,
a bottom cover mounted to said frame with said bottom cover allowing light from said tubes to shine therethrough.

13. The light fixture of claim 12 wherein:
said end caps have mutually facing recesses with said female connectors mounted therein and said opposite ends of said LED light tubes positionable therein to protect same, said end caps further have compartments to receive wires extending from said female connectors to outwardly of said frame to a source of electrical supply.

14. An LED light connectable to an electrical source comprising:
a plurality of parallel LED light tubes having LED's mounted therein with said LED light tubes having opposite ends and first electrical connectors secured to said ends;
a pair of spaced apart end housings with mutually facing sides;
second electrical connectors mounted to said mutually facing sides with said second electrical connectors oriented on said mutually facing sides matingly receiving said first electrical connectors when said LED light tubes extend between and are mounted to said pair of end housings;
an elongated support extending between and fastened to said end housings keeping said end housings in spaced relationship with each other with said elongated support and said housings forming a frame; and,
said end housings include a light tube locator orienting said second electrical connectors and said LED light tubes positioning said LED light tubes in a pattern of different angles of illumination from said light tubes.

15. The LED light of claim 14 wherein:
said frame has an open top and open bottom extending from one end housing to the other end housing allowing air to circulate around said LED light tubes conveying heat therefrom.

16. The LED light of claim 14 wherein:
said LED light tubes include light reflectors to direct light outwardly, said locator includes a locating wall with said second electrical connectors positioned adjacent to said walls to automatically orient said reflectors of said LED light tubes to shine light downwardly at a variety of angles relative to vertical.

17. The LED light of claim 16 wherein:
said LED light tubes are arranged in a group of 2, 4, 6, or 8 pairs of LED light tubes mounted to said end housings.

18. The LED light of claim 14 and further comprising:
mounting brackets movably mounted to said end housings, said end brackets have openings thereon receiving and holding said female connectors, said brackets may be moved to orient said female connectors at different angles relative to vertical.

19. The LED light of claim 18 and further comprising:
mounting strips mounted to said end housings with said mounting brackets movably mounted to said strips, said mounting strips and mounting brackets have interacting dimple/recesses to allow said brackets to be pivoted to selected positions.
